(19) United States
(12) Patent Application Publication
(10) Pub. No.: US 2020/0159824 A1
(43) Pub. Date: May 21, 2020

(54) Dynamic Contextual Response Formulation

(71) Applicant: International Business Machines Corporation, Armonk, NY (US)

(72) Inventors: Stephen Arthur Boxwell, Columbus, OH (US); Keith Gregory Frost, Delaware, OH (US); Stanley John Vernier, Grover City, OH (US); Kyle Matthew Brake, Dublin, OH (US)

(73) Assignee: International Business Machines Corporation, Armonk, NY (US)

(21) Appl. No.: 16/191,907

(22) Filed: Nov. 15, 2018

(51) Int. Cl. G06F 17/27; G06F 17/30; G06N 99/00

(52) U.S. Cl. CPC G06F 17/2705; G06F 17/30684; G06F 17/2785; G06N 99/005; G06F 17/274; G06F 17/30696

(57) ABSTRACT

Embodiments relate to an intelligent computer platform to provide a contextual response to an interrogatory. An electronic communication interface or portal is dynamically evaluated by an artificial intelligence (AI) platform. Natural language processing (NLP) is utilized to detect and evaluate a communication, identify an interrogatory within the communication, and determine an intent of the interrogatory. A corresponding factoid pipeline is searched for content related to the intent, and a response to the interrogatory is ascertained, formulated, and presented to the electronic communication interface.

### BACKGROUND

The present embodiments relate to natural language processing. More specifically, the embodiments relate to recognizing intent present within an electronic communication and resolving the recognized intent with response data.

In the field of artificially intelligent computer systems, natural language systems (such as the IBM Watson™ artificially intelligent computer system or and other natural language interrogatory answering systems) process natural language based on knowledge acquired by the system. To process natural language, the system may be trained with data derived from a database or corpus of knowledge, but the resulting outcome can be incorrect or inaccurate for a variety of reasons.

Machine learning (ML), which is a subset of Artificial intelligence (AI), utilizes algorithms to learn from data and create foresights based on this data. AI refers to the intelligence when machines, based on information, are able to make decisions, which maximizes the chance of success in a given topic. More specifically, AI is able to learn from a data set to solve problems and provide relevant recommendations. Cognitive computing is a mixture of computer science and cognitive science. Cognitive computing utilizes self-teaching algorithms that use data minimum, visual recognition, and natural language processing to solve problems and optimize human processes.

At the core of AI and associated reasoning lies the concept of similarity. The process of understanding natural language and objects requires reasoning from a relational perspective that can be challenging. Structures, including static structures and dynamic structures, dictate a determined output or action for a given determinate input. More specifically, the determined output or action is based on an express or inherent relationship within the structure. This arrangement may be satisfactory for select circumstances and conditions. However, it is understood that dynamic structures are inherently subject to change, and the output or action may be subject to change accordingly. Existing solutions for efficiently identifying objects and understanding natural language and processing content response to the identification and understanding as well as changes to the structures are extremely difficult at a practical level.

### SUMMARY

The embodiments include a system, computer program product, and method for dynamically evaluating and processing an electronic communication.

In one aspect, a system is provided for use with an intelligent computer platform to dynamically evaluate an electronic communication, detect an interrogatory therein, and provide a corresponding contextual response. A processing unit is operatively coupled to memory and is in communication with the artificial intelligence platform. A natural language (NL) manager, in communication with the processing unit, is activated by the artificial intelligence platform and employed to observe the electronic communication. An analyzer identifies communication content, including presence of a interrogatory. NL processing (NLP) is applied to the interrogatory and functions to parse the interrogatory into components, identify an intent of the interrogatory from the components, map the intent to a content source, and determine response content as related to the interrogatory and available in the content source. A response as an answer to the interrogatory is created from the response content and presented to the electronic communication.

In another aspect, a computer program device is provided for use with an intelligent computer platform for dynamically evaluating an electronic communication. The device has program code embodied therewith. The program code is executable by a processing unit to observe the electronic communication, and identify content therein. The content identification includes identification of an interrogatory within the content. Program code is provided to apply natural language processing (NLP) to the interrogatory, parse the interrogatory into components, identify an intent of the interrogatory from the components, map the intent to a content source, and determine response content as related to the interrogatory and available in the content source. A response as an answer to the interrogatory is created from the response content and presented to the electronic communication.

In yet another aspect, a method is provided for use by an intelligent computer platform for dynamically evaluating an electronic communication. The method supports observing the electronic communication, and identifying content therein. The content identification includes identification of an interrogatory within the content. Natural language processing (NLP) is applied to the interrogatory for parsing the interrogatory into components, identifying an intent of the interrogatory from the components, mapping the intent to a content source, and determining response content as related to the interrogatory and available in the content source. A response as an answer to the interrogatory is created from the response content and presented to the electronic communication.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings reference herein forms a part of the specification. Features shown in the drawings are meant as illustrative of only some embodiments, and not of all embodiments, unless otherwise explicitly indicated.

FIG. 1 depicts a system diagram illustrating a natural language processing (NLP) system connected in a network environment that identifies and analyzes electronic communications.

FIG. 2 depicts a block diagram illustrating the natural language processing tools, as shown and described in FIG. 1, and their associated application program interfaces.

FIGS. 3A and 3B depict a flow chart illustrating dynamic evaluation of a communication to ascertain and evaluate an interrogatory within the communication.

FIG. 4 depicts a flow chart illustrating a process for clarifying the identified interrogatory.

FIG. 5 depicts a flow chart illustrating a usecase of the tools shown in FIGS. 1 and 2, and the processes shown in FIGS. 3A, 3B and 4.

FIG. 6 depicts a block diagram illustrating an example of a computer system/server of a cloud based support system, to implement the system and processes described above with respect to FIGS. 1-5.

FIG. 7 depicts a block diagram illustrating a cloud computer environment.

FIG. 8 depicts a block diagram illustrating a set of functional abstraction model layers provided by the cloud computing environment.

### DETAILED DESCRIPTION

It will be readily understood that the components of the present embodiments, as generally described and illustrated in the Figures herein, may be arranged and designed in a wide variety of different configurations. Thus, the following details description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

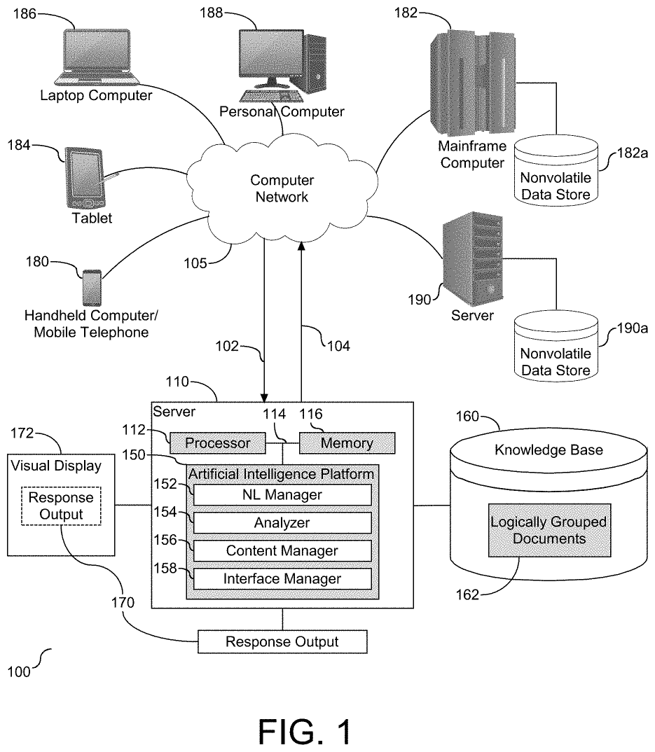

Referring to FIG. 1, a schematic diagram of a natural language processing system (100) is depicted. As shown, a server (110) is provided in communication with a plurality of computing devices (180), (182), (184), (186), and (188) across a network connection (105). The server (110) is configured with a processing unit in communication with memory across a bus. The server (110) is shown with an artificial intelligence platform (150) for natural language processing over the network (105) from one or more of the computing devices (180), (182), (184), (186) and (188). More specifically, the computing devices (180), (182), (184), (186), and (188) communicate with each other and with other devices or components via one or more wired and/or wireless data communication links, where each communication link may comprise one or more of wires, routers, switches, transmitters, receivers, or the like. In this networked arrangement, the server (110) and the network connection (105) enable communication detection, recognition, and resolution. Other embodiments of the server (110) may be used with components, systems, sub-systems, and/or devices other than those that are depicted herein.

The artificial intelligence platform (150) is shown herein configured to receive input (102) from various sources. For example, artificial intelligence platform (150) may receive input from the network (105) and leverage a data source (160), also referred to herein as a corpus or knowledge base, to create output or response content. As shown, the data source (160) is configured with logically grouped documents (162). In one embodiment, the data source (160) may be configured with other or additional sources of input, and as such, the sources of input shown and described herein should not be considered limiting. Similarly, in one embodiment, the data source (160) includes structured, semi-structured, and/or unstructured content in a plurality of documents that are contained in one or more databases or corpus. The various computing devices (180), (182), (184), (186), and (188) in communication with the network (105) may include access points for logically grouped documents. Some of the computing devices may include devices for a database storing the corpus of data as the body of information used by the artificial intelligence platform (150) to generate response output (170), and to communicate the response output to a visual display (172) operatively coupled to the server or one or more of the computing devices (180)-(188) across network connection (104).

The network (105) may include local network connections and remote connections in various embodiments, such that the artificial intelligence platform (150) may operate in environments of any size, including local and global, e.g. the Internet. Additionally, the artificial intelligence platform (150) serves as a front-end system that can make available a variety of knowledge extracted from or represented in documents, network accessible sources and/or structured data sources. In this manner, some processes populate the artificial intelligence platform (150), with the artificial intelligence platform (150) also including input interfaces to receive requests and respond accordingly.

As shown, content may be in the form of one or more logically grouped documents or data source entries (162) for use as part of the corpus (160) of data with the artificial intelligence platform (150). The corpus (160) may include any structured and unstructured documents, including but not limited to any file, text, article, or source of data (e.g. scholarly articles, dictionary, definitions, encyclopedia references, and the like) for use by the artificial intelligence platform (150). Content users may access the artificial intelligence platform (150) via a network connection or an internet connection to the network (105), and may submit natural language input to the artificial intelligence platform (150) that may effectively determine an output response related to the input by searching content in the corpus of data local to the data source (160) or any electronic data source operatively coupled to the server (110) across the network (105).

The artificial intelligence platform (150) is shown herein with several tools to support content detection and processing, including a natural language (NL) manager (152), an analyzer (154), a content manager (156), and an interface manager (158). The NL manager (152) functions to conduct an initial analysis of a corresponding electronic communication. As further described below, the NL manager (152) is employed to detect and observe the electronic communication. In one embodiment, the communication is on-going, and the NL manager (152) functions in real-time to detect and observe the communication. For example, in one embodiment, the NL manager (152) observes communication channels to ascertain if there is an on-going communication, e.g. live text based communication. In one embodiment, the NL manager (152) functions as a background tool or process for the electronic communication detection and observation.

When the electronic communication is detected, the analyzer (154) is employed to evaluate the communication. The analyzer (154) can use a variety of protocols to parse the detected communication, including identify content within the detected communication based on the relation between signifiers, such as words, phrases, signs, and symbols, and what they stand for, their denotations, or connotation. The analyzer (154) is shown herein as a tool embedded within the artificial intelligence platform (150) and utilizes natural language processing protocols to interpret an expression and an associated intent with the electronic communication. In one embodiment, the NL manager (152) interfaces with the analyzer (154) and converts the electronic communication to well-formed content (102), e.g. natural language text, so that the content (102) may be interpreted by the analyzer (154), and the corresponding content manager (156) may provide a response in the form of one or more outcomes (170). In one embodiment, the artificial intelligence platform (150) may provide a response in the form of a ranked list of outcomes. Accordingly, the tools (152)-(156) function to dynamically observe and assess electronic communications.

Received content (102) may be processed by the IBM Watson server (110), and the corresponding artificial intelligence platform (150). As shown herein, the analyzer (154) performs an analysis on the language of the input content (102) using a variety of reasoning algorithms. There may be hundreds or even thousands of reasoning algorithms applied, each of which performs different analysis, e.g., comparisons. For example, some reasoning algorithms may look at matching of terms and synonyms within the language of the input content (102) and the found portions of the corpus of data. In one embodiment, the NL manager (152) may process the electronic communication into word vector representations to identify and extract features within the communication. Whether through use of word vector representations, or an alternative platform for processing electronic communication, the NL manager (152) processes the electronic communication in an effort to identify presence of an interrogatory, e.g. interrogatory, in the communication. In one embodiment, the platform identifies grammatical components, such as nouns, verbs, adjectives, punctuation, punctuation marks, etc. in the electronic communication. Similarly, in one embodiment, one or more reasoning algorithms may look at temporal or spatial features in language of the electronic communication. Accordingly, the NL manager (152), together with the analyzer (154), observes the electronic communication and conducts an initial assessment, e.g. preliminary assessment, to ascertain and identify an interrogatory present within the electronic communication.

In some illustrative embodiments, server (110) may be the IBM Watson™ system available from International Business Machines Corporation of Armonk, N.Y., which is augmented with the mechanisms of the illustrative embodiments described hereafter. The IBM Watson™ system may receive the detected electronic communication as input content (102) which it then analyzes to identify characteristics of the content (102) that in turn are applied to the corpus of data (160). Based on application of the content (102) to the corpus of data (160), a set of candidate outcomes are generated by looking across the corpus of data (160) for portions of the corpus of data (160) that have some potential for containing a response matching or corresponding to an intent of the identified content characteristic(s) of the content (102).

It is understood that the interrogatory may be expressly exhibited in the communication. For example, the NL manager (152) may identify a interrogatory mark within the punctuation, which is an express characteristic of a corresponding interrogatory. It is also understood that the interrogatory may be inherently present communication. For example, a interrogatory mark may not be present, but a grammatical evaluation of the communication may demonstrate that the interrogatory is present. Accordingly, the NL manager (152) parses through the observed communication to identify whether or not an interrogatory is present within the communication.

Once it an interrogatory is ascertained and identified, the interrogatory is processed to ascertain the intent, e.g. meaning, of the interrogatory so that an appropriate answer or response may be ascertained and provided. The analyzer (154) resolves the interrogatory. More specifically, the analyzer (154) applies natural language processing (NLP) to the identified interrogatory and parses the identified interrogatory into two or more grammatical components. An example of such components includes, but is not limited to, nouns, verbs, verb phrases, pronouns, adjectives, subjects, objects, and in one embodiment punctuation marks. Similarly, in one embodiment, the grammatical component identification includes the location of the identified component within the electronic communication. It is understood that the subjects of an interrogatory may be placed after the verb or between parts of the verb phrase. The analyzer (154) utilizes the parsed components of the communication to identify an intent of the interrogatory. The intent correlates to a meaning, purpose, and/or goal expressed in the interrogatory. Before the interrogatory can be resolved with an answer, it is understood that the intent must be identified and resolved. In one embodiment, the intent may be the subject of the interrogatory. NLP is the science of extracting the intention of text and relevant information from text. In one embodiment, words or phrases present in the interrogatory or present in the communication associated with the interrogatory provide clarification or context to the intent. Accordingly, the analyzer (154) evaluates context associated with the interrogatory to understand and define the intent.

The intent of the interrogatory correlates to a meaning or subject of the interrogatory. The analyzer (154) subjects the identified intent to discovery and/or analysis to facilitate and enable resolution of the interrogatory, e.g. a response. It is understood that the goal is not merely to provide a response to the interrogatory, but to provide an accurate response to the interrogatory. The analysis includes the analyzer (154) mapping the identified intent of the interrogatory to a content source or a source that would contain accurate content for the response. It is understood that in one embodiment there may be a plurality of sources available as the content source. In one embodiment, the analyzer (154) applies the identified grammatical components and subject of the communication to determine the content source. In one embodiment, the communication may identify the content source based on the subject of the communication. Accordingly, the first aspect of the analysis is directed at determining and designating an appropriate content source, and mapping the intent to the designated content source.

Once the intent is identified and the intent is mapped to the content source, the analyzer (154) ascertains response content present within the content source and related to the identified interrogatory. It is understood that in one embodiment, the content source may have an abundant quantity of content, and the analyzer (154) needs to separate or categorize the content and determine which content, if any, is related to the identified interrogatory. In one embodiment, the analyzer (154) employs machine learning (ML), and more specifically a ML tool, to identify a passage or content within the mapped source that related to the intent of the interrogatory being investigated. Response output (170) to the identified interrogatory is created and populated with the determined response content. The response output (170) is an answer to the identified interrogatory. It is understood that in one embodiment, the analyzer (154) may identify a plurality of viable response content, hereinafter referred to as candidate responses, and further functions to resolve and provide the response output (170). In one embodiment, the analyzer (154) may create an interrogatory to further define or refine the subject of the identified interrogatory, and present the created interrogatory to the electronic communication interface to engage with the communication exchange. In another embodiment, the analyzer (154) identifies relevant candidate responses within the content, applies a confidence or relevance score to each identified candidate response, conducts a ranking of the candidate responses based on the applied confidence score, and selects at least one of the candidate responses based on the ranking. Accordingly, the analyzer (154) function to identify, and in one embodiment, resolve, the response output (170) to the identified interrogatory.

Scores may be obtained from various reasoning algorithms to indicate the extent to which the candidate responses and their content are relevant, and in one embodiment, inferred, in the identified interrogatory. Each resulting score is weighted against a statistical model. The statistical model captures how well the reasoning algorithm performed at establishing the inference between the candidate responses for a particular domain. The statistical model may be used to summarize a level of confidence that the IBM Watson system has regarding evidence that the candidate response content is inferred by the interrogatory identified from the electronic communication. This process may be repeated for each of the candidate responses until the IBM Watson™ system (110) identifies candidate responses that surface as being significantly stronger than others and thus, generates a final response candidate for the response output (170), or ranked set of candidate responses.

As shown, the server (110) includes a content manager (156) operatively coupled to the analyzer (154). It is understood that the response content may or may not be in a format that is compatible with the electronic communication and the associated interface. In addition to providing the response output (170), the content manager (156) addresses content format to ensure the response content is formatted for the electronic communication and/or an associated interface. In one embodiment, the response may have an initial format that is not compatible or commensurate with the format of the electronic communication and/or associated interface. The content manager (156) evaluates the response output (170), identifies the format of the response output (170), referred to herein as a first format, and identifies the format of the electronic communication and/or associated interface, referred to herein as a second format. In the event the content manager (156) identifies that the formats are incompatible, the content manager (156) converts the response output (170) to the second format to ensure compatibility. Accordingly, in addition to resolving the interrogatory response, e.g. response data, the format of the response is evaluated and selectively converted to a format compatible with the venue of the electronic communication.

The response output (170) is directed at specific content. For example, in one embodiment, the response output (170) may be a direct answer to the interrogatory. In one embodiment, the response output (170) may be in the form of a link to a source for the response content. Similarly, in one embodiment, the response output (170) may include both content and the source link. Accordingly, the content of the response may come in different forms, or a combination of forms.

Identification of the interrogatory and a corresponding response output (170) may elicit or require clarification. In one embodiment, the response output (170) may be incomplete, and may require an explanation or further definition. As shown, an interface manager (158) is provided in the artificial intelligence platform (150) and operatively coupled to the analyzer (154), with the functionality of the interface manager (158) directed at the above-described clarification. The interface manager (158) creates a secondary interrogatory or interrogatory that is related to the identified interrogatory and the response content, and attaches the secondary interrogatory to the response output (170). In one embodiment, the secondary interrogatory is configured and articulated to further define the identified intent of the identified interrogatory. The goal of the secondary interrogatory is to provide clarity so that the analyzer (154) may provide correct and comprehensive response content direct at the identified intent. Accordingly, the secondary interrogatory is selectively employed as a tool to clarify the scope of the identified intent, and to target or narrow the response output (170).

The NL manager (152), analyzer (154), content manager (156), and interface manager (158), hereinafter referred to collectively as AI tools, are shown as being embodied in or integrated within the artificial intelligence platform (150) of the server (110). The AI tools may be implemented in a separate computing system (e.g., 190) that is connected across network (105) to the server (110). Wherever embodied, the AI tools function to evaluate electronic communication, identify presence of one or more interrogatories within the communication, and identify an intent of the identified interrogatory(s), so that a corresponding and accurate response and response content detect may be communicated as response content to provide an answer to the identified interrogatory(s).

In selected example embodiments, the analyzer (154) may be configured to apply NL processing to identify the intent of the identified interrogatory(s) by mapping parsed terms and phrases from the interrogatory to potential source content. For example, the analyzer (154) may perform a sentence structure analysis, with the analysis entailing a parse of the subject sentence(s) and the parse to denote grammatical terms and parts of speech. In one embodiment, the analyzer (154) may use a Slot Grammar Logic (SGL) parser to perform the parsing. The analyzer (154) may also be configured to apply one or more learning methods to match detected content to known interrogatories or patterns of interrogatories to decide and categorize the corresponding intent of the interrogatory.

Types of information handling systems that can utilize the artificial intelligence platform (150) range from small handheld devices, such as handheld computer/mobile telephone (180) to large mainframe systems, such as mainframe computer (182). Examples of handheld computer (180) include personal digital assistants (PDAs), personal entertainment devices, such as MP4 players, portable televisions, and compact disc players. Other examples of information handling systems include pen, or tablet computer (184), laptop, or notebook computer (186), personal computer system (188), and server (190). As shown, the various information handling systems can be networked together using computer network (105). Types of computer network (105) that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems may use separate nonvolatile data stores (e.g., server (190) utilizes nonvolatile data store (190a), and mainframe computer (182) utilizes nonvolatile data store (182a). The nonvolatile data store (182a) can be a component that is external to the various information handling systems or can be internal to one of the information handling systems.

The information handling system employed to support the artificial intelligence platform (150) may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory. In addition, an information handling system need not necessarily embody the north bridge/south bridge controller architecture, as it will be appreciated that other architectures may also be employed.

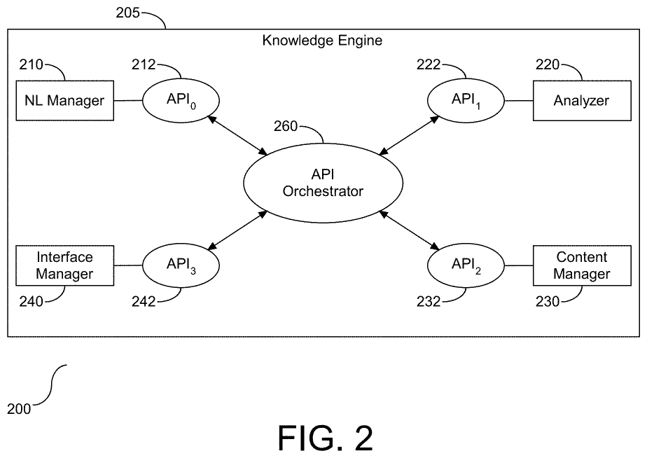

An Application Program Interface (API) is understood in the art as a software intermediary between two or more applications. With respect to the artificial intelligence platform (150) shown and described in FIG. 1, one or more APIs may be utilized to support one or more of the tools (152)-(158) and their associated functionality. Referring to FIG. 2, a block diagram (200) is provided illustrating the tools (152)-(158) and their associated APIs. As shown, a plurality of tools are embedded within the knowledge engine (205), with the tools including the NL manager (210) associated with API₀ (212), the analyzer (220) associated with API₁ (222), the content manager (230) associated with API₂ (232), and the interface manager (240) associated with API₃ (242). Each of the APIs may be implemented in one or more languages and interface specifications. API₀ (212) provides functional support to observe the electronic communication; API₁ (222) provides functional support to identify communication content, presence of a interrogatory in the content, and identify intent of the interrogatory; API₂ (232) provides functional support to format the response and response content, including conversion of formats when deemed necessary; and API₃ (242) provides functional support to create one or more secondary interrogatories to further refine the response content. As shown, each of the APIs (212), (222), (232), and (242) are operatively coupled to an API orchestrator (260), otherwise known as an orchestration layer, which is understood in the art to function as an abstraction layer to transparently thread together the separate APIs. In one embodiment, the functionality of the separate APIs may be joined or combined. As such, the configuration of the APIs shown herein should not be considered limiting. Accordingly, as shown herein, the functionality of the tools may be embodied or supported by their respective APIs.

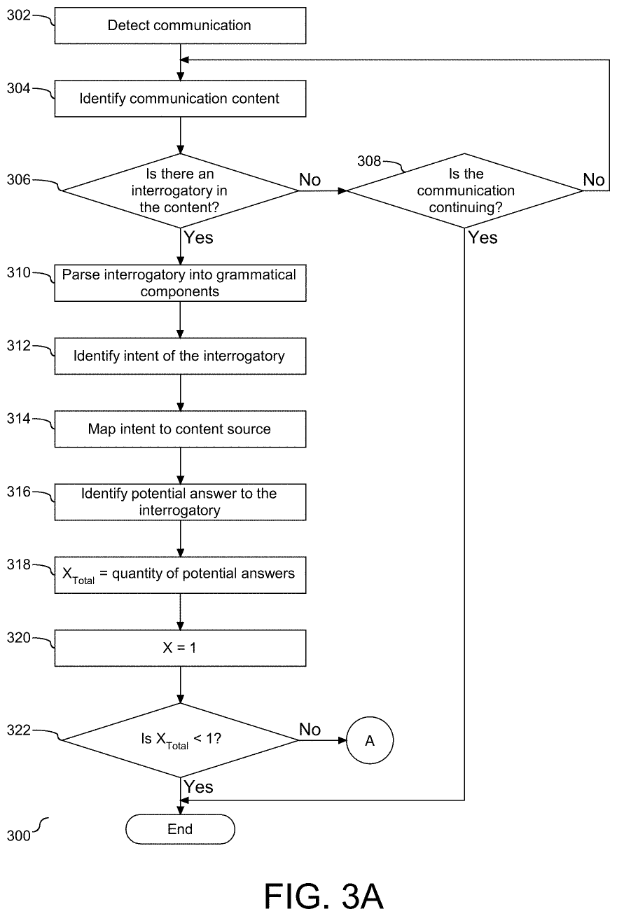

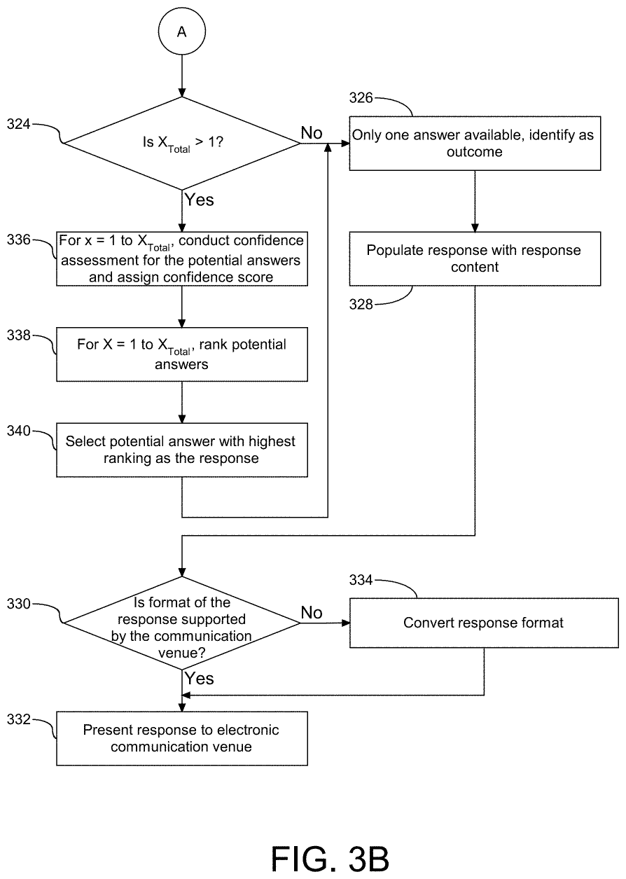

Referring to FIGS. 3A and 3B, a flow chart (300) is provided illustrating dynamic evaluation of a communication to ascertain and evaluate an interrogatory within the communication. As shown, a communication in an associated interface is detected (302). The communication may come in different formats, such as text or speech. Regardless of the format, the content of the communication is identified (304), and it is determined if a interrogatory is present in the content (306). As described in FIG. 1, the presence of the interrogatory may be expressly defined within the communication, or in one embodiment inherently defined within the communication. Regardless of whether it is express or inherent, a negative response to the determination is followed by determining if the communication, e.g. conversation, is continuing (308). A negative response to the determination at step (308) is followed by concluding the interrogatory evaluation process. However, a positive response to the determination at step (308) is followed by a return to step (304) to dynamically continue the evaluation of the communication. Accordingly, the first aspect of the dynamic evaluation is directed at communication.

A positive response to the determination at step (306) is an indication that an interrogatory of some form has been identified in the electronic communication. The identified interrogatory is parsed into grammatical components (310). In one embodiment, a parser is employed at step (310). Based on the parse of the interrogatory, the intent, e.g. meaning, of the interrogatory is identified so that an appropriate answer or response may be ascertained and provided (312). The identified intent is then mapped to a content source (314). In one embodiment, the content source may be a web site. Similarly, in another embodiment, the content source may be a structured library. The intent is submitted to the mapped content source to search for an outcome, e.g. a potential answer to the interrogatory identified in the communication, (316). It is understood that the search may reveal no outcomes, a single outcome, or a plurality of outcomes. Accordingly, following the intent identification, potential answers corresponding to the intent are identified for review.

The variable X_{Total} is assigned to the quantity of potential answers to the interrogatory under review (318), and a corresponding potential answer counting variable, X, is initialized (320). It is then determined if the quantity of potential answers or outcomes, X_{Total}, is less than one (322). A positive response to the determination concludes the interrogatory evaluation process (324). However, a negative response to the determination at step (322) is an indication that there is at least one potential answer to the interrogatory. It is then determined if the quantity of potential answers or outcomes, X_{Total}, is greater than one (324). A negative response to the determination at step (324) is an indication that there is only one potential answer to the interrogatory. The potential answer is identified as an outcome to the response (326). In one embodiment, as shown herein, the response is populated with response content and/or a link to a source, e.g. web site or web site page, of the response (328). Prior to presenting the response as an answer to the interrogatory, it is determined if the format of the response is supported by the format or venue of the electronic communication (330). A positive response to the determination at step (330) is followed by presenting the response, and in one embodiment the response content, to the electronic communication venue as a response to the identified interrogatory (332). However, a negative response to the determination at step (330) is followed by converting the response format to a format compatible with the format or venue of the electronic communication (334), and after completion of the conversion the process proceeds to step (332) for presentation of the response to the interrogatory. Accordingly, as shown herein, in the event there is only one potential answer to the interrogatory identified, the answer is processed as the response.

As shown at step (324), it is understood that two or more potential answers to the interrogatory may be initially identified. A confidence assessment is conducted for each of the potential answers, with a corresponding confidence score assigned to each of the potential answers (336). Following the confidence assessment, a ranking of the potential answers is conducted based on the associated confidence score (338), and the potential answer with the highest ranking, e.g. highest confidence score, is selected (340). Thereafter, the process proceeds to step (326) for presentation of the selected potential answer as a response to the identified interrogatory. Accordingly, in the event there is a plurality of potential answers to the interrogatory, a confidence assessment and ranking of the potential answers is conducted.

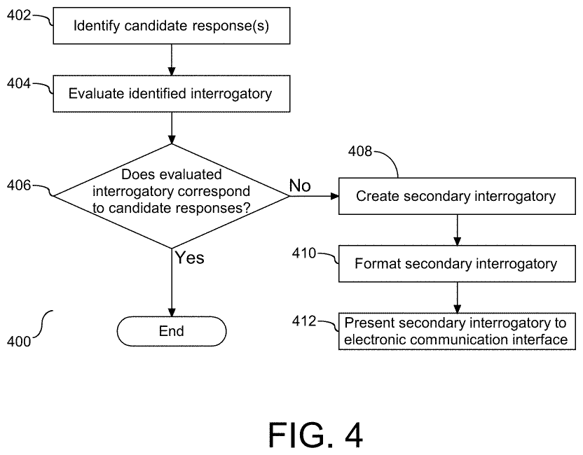

It is understood that identification of the interrogatory and a corresponding response may elicit or require clarification. For example, in one embodiment, the response may be incomplete, and may require an explanation or further definition. Referring to FIG. 4, a flow chart (400) is provided illustrating a process for clarifying the identified interrogatory. Prior to initiating or identifying a need for clarification, the candidate response(s), and in one embodiment associated response content, is identified (402). The identified interrogatory from the electronic communication is evaluated (404). In one embodiment, the evaluation at step (404) includes parsing the interrogatory into grammatical components and identifying the subject of the interrogatory. Similarly, in one embodiment, the candidate response(s) is parsed to identify the subject of the response(s). A determination is conducted to assess if the evaluated interrogatory and the candidate response(s) correspond (406). In one embodiment, the evaluation at step (406) may determine if the subjects match. A positive response to the determination at step (406) concludes the clarification process. However, a negative response to the determination at step (406) is an indication that the identified interrogatory is not producing appropriate, e.g. relevant, candidate responses, and a secondary interrogatory or interrogatory that is related to the identified interrogatory and the response content is created (408). The secondary interrogatory is configured and articulated to further define the identified intent of the identified interrogatory. The secondary interrogatories is subject to formatting (410), if necessary, and presented to the electronic communication and associated interface (412). The goal of the secondary interrogatory is to provide clarity so that accurate and comprehensive response content directed at the identified intent may be discovered. Accordingly, the secondary interrogatory is selectively employed as a tool to clarify the scope of the identified intent, and to target or narrow the candidate response.

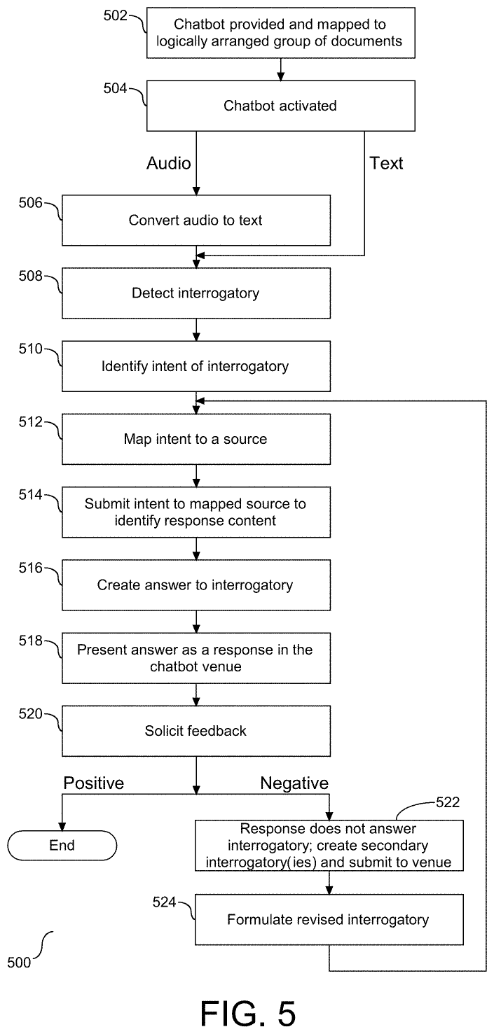

Referring to FIG. 5, a flow chart (500) is provided to illustrate a usecase of the tools shown in FIGS. 1 and 2, and the processes shown in FIGS. 3A, 3B and 4. A chatbot, also referred to herein as an artificial conversational entity, is provided in an electronic environment and mapped to a logically arranged group of documents (502). The chatbot is a computer program that simulates or attempts to simulate interactive human conversation via text or voice interactions. The chatbot is activated based on a received signal (504), e.g. text or audio signal. If the received signal is an audio signal, a natural language tool converts received audio to a text format (506). Following the conversation at step (506) or if the signal received at step (504) is text based, a interrogatory in the signal is detected (508). It is understood that if a interrogatory is not detected and the chatbot remains in an active state, e.g. the communication continues, the program continues to evaluate the conversation to detect presence of a interrogatory. Following the interrogatory detection at step (508), the intent, e.g. meaning, of the interrogatory is identified (510). The identified intent is mapped to a source (512), such as a web site, document, or a structured document source. The identified intent is submitted to the mapped source to identify response content (514). In one embodiment, a deep learning tool is utilized to identify relevant response content in the mapped source. An answer to the identified interrogatory is created (516), and in one embodiment, presented as a response in the interactive conversation venue of the chatbot (518). Direct feedback may be solicited in the conversation venue (520). If the solicited feedback is positive, the process concludes. However, if the feedback is negative, e.g. the response does not answer the identified interrogatory, the computer program creates one or more secondary interrogatories and submits them into the interactive conversation venue (522). Following receipt of response data received in the interactive conversation venue, a revised or new interrogatory is formulated (524), and the process returns to step (512) for processing of the revised or new interrogatory. Accordingly, the usecase shown herein demonstrates a dynamic environment for electronic communication processing and evaluation.

Embodiments shown and described herein may be in the form of a computer system for use with an intelligent computer platform for providing dynamic interrogatory identification and analysis for development of a corresponding contextual response, and in one embodiment, contextual response data. A processing unit is operatively coupled to memory and is in communication with an artificial intelligence platform. A tool, in communication with the processing unit, is activated by the artificial intelligence platform and employed to provide the interrogatory identification and analysis. As described herein, the interrogatory is identified from an electronic communication, and in one embodiment, a corresponding communication interface. The intent of the interrogatory is identified, whereby the meaning of the interrogatory correlates to a subject of the interrogatory.

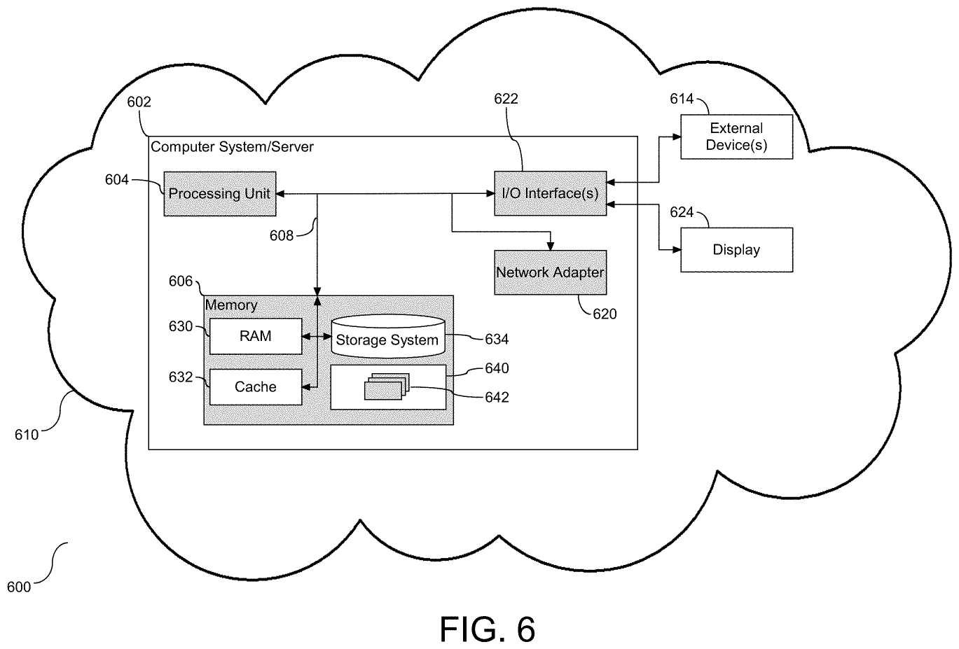

Aspect of the interrogatory identification and processing shown in FIGS. 1-5, employs one or more functional tools, as shown and described in FIG. 1. Aspects of the functional tools (152)-(158) and their associated functionality may be embodied in a computer system/server in a single location, or in one embodiment, may be configured in a cloud based system sharing computing resources. With references to FIG. 6, a block diagram (600) is provided illustrating an example of a computer system/server (602), hereinafter referred to as a host (602) in communication with a cloud based support system, to implement the processes described above with respect to FIGS. 3-5. Host (602) is operational with numerous other general purpose or special purpose computing system environments or configurations. Examples of well-known computing systems, environments, and/or configurations that may be suitable for use with host (602) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

Host (602) may be described in the general context of computer system-executable instructions, such as program modules, being executed by a computer system. Generally, program modules may include routines, programs, objects, components, logic, data structures, and so on that perform particular tasks or implement particular abstract data types. Host (602) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, host (602) is shown in the form of a general-purpose computing device. The components of host (602) may include, but are not limited to, one or more processors or processing units (604), e.g. hardware processors, a system memory (606), and a bus (608) that couples various system components including system memory (606) to processor (604). Bus (608) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Host (602) typically includes a variety of computer system readable media. Such media may be any available media that is accessible by host (602) and it includes both volatile and non-volatile media, removable and non-removable media.

Memory (606) can include computer system readable media in the form of volatile memory, such as random access memory (RAM) (630) and/or cache memory (632). By way of example only, storage system (634) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (608) by one or more data media interfaces.

Program/utility (640), having a set (at least one) of program modules (642), may be stored in memory (606) by way of example, and not limitation, as well as an operating system, one or more application programs, other program modules, and program data. Each of the operating systems, one or more application programs, other program modules, and program data or some combination thereof, may include an implementation of a networking environment. Program modules (642) generally carry out the functions and/or methodologies of embodiments to dynamically communication evaluation interrogatory identification and processing. For example, the set of program modules (642) may include the tools (152)-(158) as described in FIG. 1.

Host (602) may also communicate with one or more external devices (614), such as a keyboard, a pointing device, etc.; a display (624); one or more devices that enable a user to interact with host (602); and/or any devices (e.g., network card, modem, etc.) that enable host (602) to communicate with one or more other computing devices. Such communication can occur via Input/Output (I/O) interface(s) (622). Still yet, host (602) can communicate with one or more networks such as a local area network (LAN), a general wide area network (WAN), and/or a public network (e.g., the Internet) via network adapter (620). As depicted, network adapter (620) communicates with the other components of host (602) via bus (608). In one embodiment, a plurality of nodes of a distributed file system (not shown) is in communication with the host (602) via the I/O interface (622) or via the network adapter (620). It should be understood that although not shown, other hardware and/or software components could be used in conjunction with host (602). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (606), including RAM (630), cache (632), and storage system (634), such as a removable storage drive and a hard disk installed in a hard disk drive.

Computer programs (also called computer control logic) are stored in memory (606). Computer programs may also be received via a communication interface, such as network adapter (620). Such computer programs, when run, enable the computer system to perform the features of the present embodiments as discussed herein. In particular, the computer programs, when run, enable the processing unit (604) to perform the features of the computer system. Accordingly, such computer programs represent controllers of the computer system.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments.

In one embodiment, host (602) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

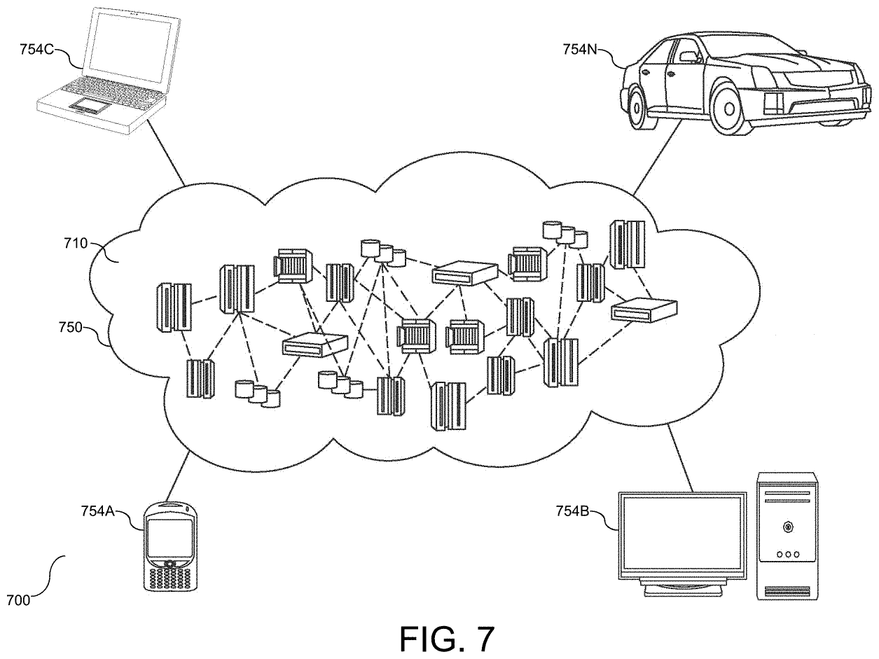

Referring now to FIG. 7, an illustrative cloud computing network (700). As shown, cloud computing network (700) includes a cloud computing environment (750) having one or more cloud computing nodes (710) with which local computing devices used by cloud consumers may communicate. Examples of these local computing devices include, but are not limited to, personal digital assistant (PDA) or cellular telephone (754A), desktop computer (754B), laptop computer (754C), and/or automobile computer system (754N). Individual nodes within nodes (710) may further communicate with one another. They may be grouped (not shown) physically or virtually, in one or more networks, such as Private, Community, Public, or Hybrid clouds as described hereinabove, or a combination thereof. This allows cloud computing environment (700) to offer infrastructure, platforms and/or software as services for which a cloud consumer does not need to maintain resources on a local computing device. It is understood that the types of computing devices (754A-N) shown in FIG. 7 are intended to be illustrative only and that the cloud computing environment (750) can communicate with any type of computerized device over any type of network and/or network addressable connection (e.g., using a web browser).

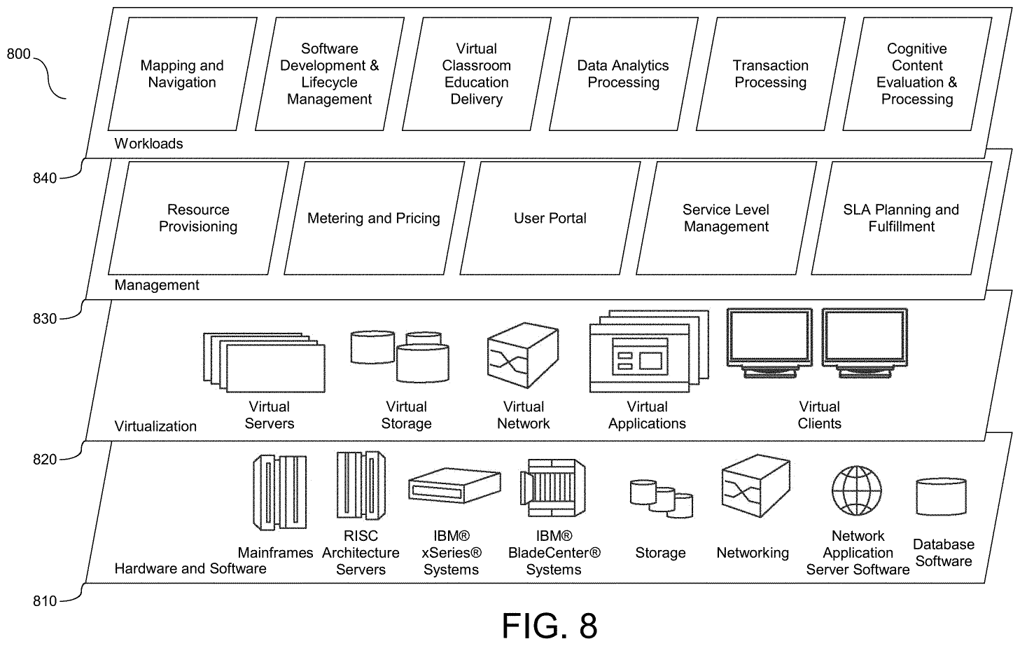

Referring now to FIG. 8, a set of functional abstraction layers (800) provided by the cloud computing network of FIG. 7 is shown. It should be understood in advance that the components, layers, and functions shown in FIG. 8 are intended to be illustrative only, and the embodiments are not limited thereto. As depicted, the following layers and corresponding functions are provided: hardware and software layer (810), virtualization layer (820), management layer (830), and workload layer (840).

The hardware and software layer (810) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (820) provides an abstraction layer from which the following examples of virtual entities may be provided: virtual servers; virtual storage; virtual networks, including virtual private networks; virtual applications and operating systems; and virtual clients.

In one example, management layer (830) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

Workloads layer (840) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and dynamic content evaluation and processing.

It will be appreciated that there is disclosed herein a system, method, apparatus, and computer program product for evaluating natural language input, detecting an interrogatory in a corresponding communication, and resolving the detected interrogatory with an answer and/or supporting content.

While particular embodiments of the present embodiments have been shown and described, it will be obvious to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “one or more” or “at least one” and indefinite articles such as “a” or “an”; the same holds true for the use in the claims of definite articles.

The present embodiments may be a system, a method, and/or a computer program product. In addition, selected aspects of the present embodiments may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present embodiments may take the form of computer program product embodied in a computer readable storage medium (or media) having computer readable program instructions thereon for causing a processor to carry out aspects of the present embodiments. Thus embodied, the disclosed system, a method, and/or a computer program product is operative to improve the functionality and operation of an artificial intelligence platform to resolve interrogatories with intent identification and a corresponding response related to the identified intent.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

Aspects of the present embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments have been described herein for purposes of illustration, various modifications may be made without departing from the spirit and scope of the embodiments. In particular, the natural language processing may be carried out by different computing platforms or across multiple devices. Furthermore, the data storage and/or corpus may be localized, remote, or spread across multiple systems. Accordingly, the scope of protection of the embodiments is limited only by the following claims and their equivalents.

What is claimed is:

1. A computer system comprising:
a processing unit operatively coupled to memory;
an artificial intelligence platform, in communication with the processing unit, the platform to dynamically evaluate an electronic communication, the platform including:
a natural language (NL) manager to observe the electronic communication;
an analyzer to identify content of the observed communication, including identification of a interrogatory present within the identified content;
the analyzer to apply natural language processing (NLP) to the identified interrogatory, including:
parse the identified interrogatory into two or more grammatical components; and
utilize the parsed components to identify an intent of the interrogatory, wherein the intent correlates to a meaning of the interrogatory;
analyze the identified intent, including:
map the identified intent to a content source; and
determine response content within the content source related to the identified interrogatory; and
output a response including the response content, wherein the response output includes an answer to the identified interrogatory.

2. The system of claim 1, wherein the response content includes two or more candidate responses, and further comprising the analyzer to apply a confidence score to each candidate response, rank the two or more candidate responses based on the applied confidence score, and select at least one of the candidate responses as the response output based on the ranking.

3. The system of claim 1, further comprising a content manager, operatively coupled to the analyzer, the content manager to convert the response output to a format of the observed electronic communication, and return the response output in the format in an associated natural language interface.

4. The system of claim 3, further comprising the content manager to create a link to the response within the content source, and attach the created link to the response output.

5. The system of claim 1, further comprising an interface manager, operatively coupled to the analyzer, the interface manager to create a secondary interrogatory related to the identified interrogatory and the response output, and attach the secondary interrogatory to the response output.

6. The system of claim 5, wherein the secondary interrogatory further defines the identified intent of the identified interrogatory.

7. A computer program product for dynamically evaluating an electronic communication, the computer program product comprising a computer readable storage medium having program code embodied therewith, the program code executable by a processor to:
observe the electronic communication;
identify content of the observed communication, including identification of a interrogatory present within the identified content;
apply natural language processing (NLP) to the identified interrogatory, including:
parse the identified interrogatory into two or more grammatical components; and
utilize the parsed components to identify an intent of the interrogatory, wherein the intent correlates to a meaning of the interrogatory;
analyze the identified intent, including:
map the identified intent to a content source; and
determine response content within the content source related to the identified interrogatory; and
output a response including the response content, wherein the response output includes an answer to the identified interrogatory.

8. The computer program product of claim 7, wherein the response content includes two or candidate responses, and further comprising program code to apply a confidence score to each candidate response, rank the two or more candidate responses based on the applied confidence score, and select at least one of the candidate responses as the response output based on the ranking.

9. The computer program product of claim 7, further comprising program code to convert the response output to a format of the observed electronic communication, and return the response output in the format in an associated natural language interface.

10. The computer program product of claim 9, further comprising program code to create a link to the response within the content source, and attach the created link to the response output.

11. The computer program product of claim 7, further comprising program code to create a secondary interrogatory related to the identified interrogatory and the response output, and attach the secondary interrogatory to the response output.

12. The computer program product of claim 11, wherein the secondary interrogatory further defines the identified intent of the identified interrogatory.

13. A method for dynamically evaluating an electronic communication comprising:
observing the electronic communication,
identifying content of the observed communication, including identifying a interrogatory present within the identified content;
applying natural language processing (NLP) to the identified interrogatory,
including:
parsing the identified interrogatory into two or more grammatical components; and
utilizing the parsed components to identify an intent of the interrogatory, wherein the intent correlates to a meaning of the interrogatory;
analyzing the identified intent, including:
mapping the identified intent to a content source; and
determining response content within the content source related to the identified interrogatory; and
output a response including the response content, wherein the response output includes an answer to the identified interrogatory.

14. The method of claim 13, wherein the response content includes two or more candidate responses, and further comprising applying a confidence score to each candidate response, ranking the two or more candidate responses based on the applied confidence score, and selecting the response output based on the ranking.

15. The method of claim 13, further comprising converting the response output to a format of the observed electronic communication, and returning the response output in the format in an associated natural language interface.

16. The method of claim 15, further comprising creating a link to the response within the content source, and attaching the created link to the response output.

17. The method of claim 13, further comprising creating a secondary interrogatory related to the identified interrogatory and the response output, and attaching the secondary interrogatory to the response output.

18. The method of claim 17, wherein the secondary interrogatory further defines the identified intent of the identified interrogatory.
